(19) United States
(12) Patent Application Publication
(10) Pub. No.: US 2014/0308433 A1
(43) Pub. Date: Oct. 16, 2014

(54) COMPOSITE ARTICLE CURING

(71) Applicant: Joseph Ouellette, Tecumseh (CA)

(72) Inventor: Joseph Ouellette, Tecumseh (CA)

(21) Appl. No.: 14/238,156

(22) PCT Filed: Aug. 13, 2012
(86) PCT No.: PCT/CA2012/000764

§ 371 Date: May 19, 2014

Related U.S. Application Data
(60) Provisional application No. 61/522,802, filed on Aug. 12, 2011.

(51) Int. Cl. B05B 12/10; B05D 1/00; B05C 9/04; B05D 7/22

(52) U.S. Cl. CPC B05B 12/10; B05D 7/22; B05D 1/002; B05C 9/045
USPC 427/8; 427/230; 427/231; 427/386; 118/58; 118/666

(57) ABSTRACT

Described herein are methods and systems for the manufacture of composite articles, wherein a composite article is manufactured using a filamentary material and a liner, comprising: providing a material in heat transfer relation with the inner surface of said liner; applying uncured filamentary material to the outer surface of said liner; and heating a portion of said material in heat transfer relation with the inner surface of said liner, wherein heating said portion of said material effects cure of said composite article. Also in the methods and systems herein, a composite article is manufactured using a filamentary material wound on a liner, comprising, a material in heat transfer relation with the inner surface of said liner; heating means operable to heat a portion of said material in heat transfer relation with the inner surface of said liner, wherein heating said portion of said material effects cure of said composite vessel.

### FIELD OF THE INVENTION

The field of the invention generally relates to composite articles.

### BACKGROUND OF THE INVENTION

Filament wound composite vessels, pipe segments and composite articles are commonly used in a variety of fields due to their beneficial properties, including their strength and light weight. In manufacture, a mandrel is employed as a form around which a filament is wound.

Filament wound composite pressure vessels are used in a variety of fields due to their beneficial properties, including their strength and light weight.

In manufacture, a composite article, such as composite pressure vessel, can be formed by filament winding or placing fiber around a liner to obtain a suitable thickness and size for the pressure vessel. The resulting uncured work piece is typically heated in an oven to cure. During heating, resin changes phase from liquid to solid. In this process, the resin encapsulates the filament, thereby containing it in its wound orientation, and holding it in the same orientation as the resin hardens. Heating can also activate curing agents in the filament. The work piece is heated for a predetermined amount of time and is then removed from the oven.

In such a process, heat is applied to the outer surface of an uncured composite vessel, resulting in the heating of the vessel from the outer surface to the inner surface. During the heating process, vapors such as water vapour, carbon dioxide, styrene and other vaporous compounds may be generated which pass through the fiber/polymer filamentary matrix, through the uncured layers, to the atmosphere. However, a cured matrix may prevent the vapors from escaping from the inner layers of the vessel, which may result in the formation of bubbles or voids in the structure of the matrix. Such voids or bubbles may result in micro cracking or porosity at the inner surface of the pressure vessel.

There remains a need for improved manufacture of composite articles, including pressure vessels.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

In accordance with an aspect of the present invention, there is provided a method of manufacture of a composite article using a filamentary material and a liner, comprising: providing a material in heat transfer relation with the inner surface of said liner; applying uncured filamentary material to the outer surface of said liner; and heating a portion of said material in heat transfer relation with the inner surface of said liner, wherein heating said portion of said material effects cure of said composite article.

In a specific aspect, said material comprises a metallic material.

In a specific aspect, said metallic material comprises copper, nickel, steel, aluminum, bismuth, or antimony.

In a specific aspect, applying said uncured filamentary material comprises rotating said liner about an axis of said liner and applying said filamentary material around the outer surface of said vessel.

In a specific aspect, applying said uncured filamentary material comprises maintaining said liner in a fixed position and rotating dispensing means around the outer surface of said liner so as to apply said filamentary material.

In a specific aspect, applying said uncured filamentary material comprises rotating said liner about an axis of said liner and applying said filamentary material around the outer surface of said vessel and rotating dispensing means around the outer surface of said liner so as to apply said filamentary material.

In a specific aspect, said axis is a longitudinal axis.

In a specific aspect, said heating of said portion of said material occurs subsequent to applying said uncured composite materials to said outer surface of said liner.

In a specific aspect, said heating of said portion of said material occurs concurrently with applying said uncured composite materials to said outer surface of said liner.

In a specific aspect, said method further comprises monitoring and controlling the temperature of said material in said liner.

In a specific aspect, said monitoring and controlling is effected using a contact sensor or a non contact sensor, and a control loop operatively associated with an induction power supply and a heat source to maintain a set temperature.

In a specific aspect, said heat source is internal to said liner or external to said liner.

In a specific aspect, said heat source is an induction coil.

In a specific aspect, said method further comprises heating the outer surface of said uncured article.

In another aspect of the present invention there is provided a method of manufacture of a composite article using a filamentary material and a liner, comprising: applying uncured filamentary material to the outer surface of said liner; and providing a heated charge fluid vapor in heat transfer relation with the inner surface of said liner so as to effect cure of said uncured filamentary material, wherein said heated charge fluid vapor is in isothermal conditions in the interior of said liner.

In a specific aspect, said providing said heated charge fluid vapor comprises, providing a charge fluid to a chamber in heat transfer relation with a heating system, wherein said heating system is configured to heat said charge fluid so as to produce a heated charge fluid vapor.

In a specific aspect, said heating system comprises, an induction heating coil in heat transfer relation with said chamber and a said induction heating coil is operatively associated with a contact temperature sensor or a non contact temperature sensor and a control loop operatively associated with an induction power supply, wherein said heating system is operable to maintain a set temperature.

In accordance with another aspect of the present invention, there is provided a system for the manufacture of a composite article using a filamentary material wound on a liner, comprising: a source of heated vapor in fluid communication with the interior of said liner and configured to provide heated vapor to the interior of said liner; and outlet means movable between an open position and a closed position, wherein in said open position the interior of said liner is in fluid communication with the exterior of said liner, wherein in said closed position the interior of said liner is not in fluid communication with the exterior of said liner, wherein said source of heated vapor is operable to provide said heated vapor to the interior of said liner under isothermal conditions.

In a specific aspect, said source of heated vapor comprises, a chamber for receiving a charge fluid from a source of charge fluid; and a heating system configured to heat said charge fluid in said chamber.

In a specific aspect, said heating system comprises, an induction heating coil in heat transfer relation with said chamber and a said induction heating coil is operatively associated with a contact temperature sensor or a non contact temperature sensor and a control loop operatively associated with an induction power supply, wherein said heating system is operable to maintain a set temperature.

In accordance with another aspect of the present invention there is provided a system for the manufacture of a composite article using a filamentary material wound on a liner, comprising, a material in heat transfer relation with the inner surface of said liner; heating means operable to heat a portion of said material in heat transfer relation with the inner surface of said liner, wherein heating said portion of said material effects cure of said composite vessel.

In a specific aspect, said material comprises a metallic material.

In a specific aspect, said metallic material comprises copper, nickel, steel, aluminum, bismuth, or antimony.

In a specific aspect, said heating of said portion of said material occurs subsequent to applying said uncured composite materials to said outer surface of said liner.

In a specific aspect, said heating of said portion of said material occurs concurrently with applying said uncured composite materials to said outer surface of said liner.

In a specific aspect, said system further comprises monitoring and controlling means operable to monitor and control the temperature of said material in said liner.

In a specific aspect, said monitoring and controlling is effected using a contact sensor or a non contact sensor, and a control loop operatively associated with an induction power supply and a heat source to maintain a set temperature.

In a specific aspect, said heat source is internal to said liner or external to said liner.

In a specific aspect, said heat source is an induction coil.

### BRIEF DESCRIPTION OF THE DRAWINGS

Embodiments of the present invention will now be described, by way of example only, with reference to the attached Figures, wherein:

FIG. 1 illustrates a cross section of one embodiment of the present invention;

FIG. 2 illustrates a cross section of one embodiment of the present invention;

FIG. 3 illustrates a cross section of one embodiment of the present invention;

FIG. 4 illustrates a cross section of one embodiment of the present invention; and

FIG. 5 illustrates a cross section of one embodiment of the present invention.

In the detailed description that follows, the numbers in bold face type serve to identify the component parts that are described and referred to in relation to the drawings depicting various embodiments of the invention. It should be noted that in describing various embodiments of the present invention, the same reference numerals have been used to identify the same of similar elements. Moreover, for the sake of simplicity, parts have been omitted from some figures of the drawings.

### DETAILED DESCRIPTION

Filament wound composite vessels, pipe segments and composite articles are commonly used in a variety of fields due to their beneficial properties, including their strength and light weight. In manufacture, a mandrel is employed as a form around which a filament is wound.

It will be clear that pipe, tube or other hollow sections of various geometries, such as ovoid, square, rectangular etc., with parallel sides or having a draft, may be made as composite articles. Vessels with one open end may also be used. Vessels with more than one open end may be also be used.

A composite pressure vessel is a pressure vessel whose structure is of composite material, as is well known to the skilled worker. In one example of the present invention, a composite pressure vessel is a filament-wound structure.

Composite articles of the present invention, such as composite pressure vessels, are suitable for use in a variety of applications, including storing various liquid(s) or gaseous media, such as compressed or liquefied gases, liquids, propellants, and the like, for extended periods of time and often at high pressure(s). For example, composite pressure vessels are used to store nitrogen gas, hydrogen gas, propane gas, natural gas, oxygen, air, water and the like.

Composite pressure vessels of the present invention may be used in a wide range of applications including, but not limited to, air suspension reservoirs, pneumatic brake reservoirs, air propulsion reservoirs, nitrogen gas storage vessels, propane gas storage vessels, natural gas storage vessels, air storage vessels, water storage vessels, components of fuel cells, fuel tanks, components of space craft, and the like.

It will be appreciated that composite vessels of the present invention are manufactured to accommodate the medium and/or pressurized medium. As such, the composite pressure vessels are made from a variety of materials, including, but not limited to, graphite, aramid, fiber glass, Kevlar, synthetic plastic material fibers, and the like, and of materials such as epoxy thermoset resins or various thermoplastic resins such as polypropylene Nylon etc., capable of forming a matrix embedding such filaments/materials and bonding them together in a composite material.

A composite articles of the present invention, including composite vessels, may be a variety of shapes and sizes, as will be determined in part by the intended use, manufacturing tolerances, user preference, and the like. Composite vessels with more than one opening and/or more than one open end may be used. Pipe, tube or other hollow sections of various geometries, such as ovoid, square, rectangular etc., with parallel sides or having a draft, may be used. Vessels with one open end may also be used. Vessels with more than one open end may be also be used.

Thus, it will be appreciated that vessels as well as articles with complex geometry winding that would require a hollow interior may be produced using the methods and systems as described herein.

Typically, a composite vessel comprises an inner liner (such as a metal liner or non-metallic liner), optionally coated with a primer, and an overwrap or jacket. The overwrap or outer jacket is constructed by superimposed and overlapping layers of resin impregnated filamentary materials, wrapped around the liner, with the interstices between the fibers or filament being filled by impregnating material such as hardenable epoxy resin that, upon setting and hardening, or thermoplastic resins that upon fusing, forms a matrix that firmly embeds such fibers or filamentary material.

After hardening, the filamentary and impregnating material together form a composite, fiber reinforced, solid body capable of withstanding the forces of the intended use.

In the embodiments of the present invention, a composite pressure vessel is formed using a vessel (i.e., the liner) of a shape and size to satisfy the inner shape of the desired pressure vessel. The liner further comprises an opening that is finished to accommodate the intended use of the vessel. In one example the vessel comprises more than one opening.

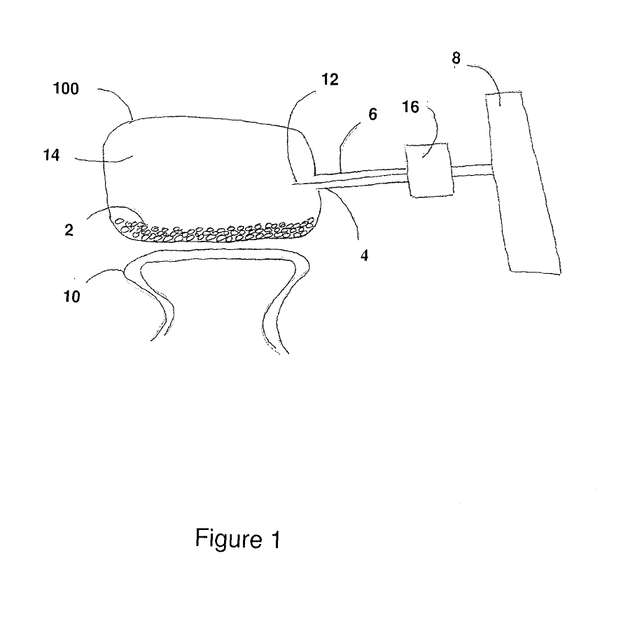

In the embodiments of FIGS. 1 to 4, a heat conductive material is placed in the interior volume of the liner in heat transfer relation with a portion of the inner surface of the liner. The amount of heat conductive material is selected so as to provide a volume of heat conductive material that will absorb energy applied to the heat conductive material and transfer energy from the heat conductive material to the interior walls of the liner as the liner rotates.

In one example, the heat conductive material is a metallic material. The amount of metallic material is selected so as to provide a volume (or amount) of metallic material that will absorb energy applied to the metallic material and transfer energy from the metallic material to the interior walls of the vessel as the vessel rotates.

The amount of metallic material is also selected so as to promote a tumbling action of said metallic material as the vessel is rotated.

It will be appreciated that the volume and amount of metallic material used is determined by evaluation of each liner shape and the size and geometry of the granules used and/or method of heating used.

The liner is releaseably attached to a first end of a support, for example by threading the liner vessel on to the first end of the support.

Fiber(s) having the required tension strength capability is wound in various layers over the liner to provide a matrix that will allow the vessel to withstand the pressure of its intended use. The fiber(s) is saturated with a resin in its uncured state. In a filament winding process, in one example, a band of continuous resin impregnated rovings or monofilaments (also referred to as filamentary material) is wrapped around the liner. In one example of the present invention, the fiber(s) is applied manually to the vessel. In another example, a continuous sheet of parallel fiber, optionally in a pre-impregnated with resin, is placed around the liner. In another example, a filament winding machine is used in the application of filamentary material. In another example, a manual or automated fiber placement machine is used in the application of the fiber sheet or filamentary material.

As noted above, in previous methods, during the traditional heating process in a cure oven, the liner surface is the last surface to achieve cure temperature. Such heating of the composite pressure vessel from the outer surface of the work piece to the inner surface can cause incomplete cure at the vessel-resin fiber interface. The trapping of vapors generated during the traditional curing process may result in the formation of bubbles or voids within the winding which makes up the composite vessel wall. This lack of cure can result in failure in the vessel in use.

In the present invention, heat is applied to the inner surface of the vessel in order to effect cure from the inner surface of the composite vessel to the outer surface. The methods of the present invention reduce, minimize or eliminate the problems associated with curing of a composite vessel from the outer surface to the inner surface of the composite vessel. In the present invention, curing of the work piece from the inner surface to the outer surface permits the vapor(s) produced during curing to exit from the curing work piece to the atmosphere. This method reduces, minimizes or eliminates the porosity within the composite vessel and provides a more predictable strength of the structure. In some instances, the methods of the present invention reduce the cure time as compared to oven curing.

FIG. 1 depicts an embodiment of the present invention, in which a composite vessel is produced by winding an epoxy impregnated filamentary material around a metallic or non-metallic liner. The method provides for curing of the filament/resin matrix from the inner surface of the filament wound work piece to the outer surface.

In FIG. 1, liner 100 is a metallic or a non-metallic liner. In one example, liner 100 comprises plastic, including but not limited to, thermoplastic, thermoset plastic and the like. In another example, liner 100 comprises metal, aluminium, copper, nickel, stainless steel, core materials used in ferrous and non-ferrous casting process such as foundry sand, and the like. In another example, liner 100 comprises glass, ceramic, fired clay, pottery, non-plastic composite materials, and the like.

Metallic material 2 is added to the interior volume of liner 100 through aperture 4. A variety of metallic materials may be used, including, but not limited to copper, nickel, steel, aluminum, mixtures thereof, and the like, as would be appreciated by the skilled worker. The metallic materials can be a variety of sizes, including granular size, nano particles and/or micro particles. The size and shape of metallic material 2 is selected based upon the vessel, ease of handling by the operator, and the like. Metallic material 2 may be homogeneous or heterogeneous with respect to size, shape and/or material(s) used. In one example, metallic material 2 is sized approximately the size of a “bb”, or number 6 to number 7 steel shot. In one example, ball bearings in the range of about ⅛^{th} inch in diameter to about ½ inch in diameter may be used. Desirably, the metallic material is installed clean so as to reduce the amount of residue in the vessel following use. In one example, the metallic material is cleaned using deionized water prior to use.

In use, metallic material 2 is in heat transfer relation with the interior surface of vessel 100.

In one example, metallic material 2 occupies between about 30% to about 50% of the volume of vessel 100.

In FIG. 1, aperture 4 of vessel 100 is removablely attachable to support 6. In one example, aperture 4 is a threaded opening configured for removable attachment to a first end of support member 6. Alternate attachment means may be used to attach liner 100 to a first end of support member 6. Support member 6 further comprises a second end which can be held on rotating chuck 8 of a filament winding machine (not shown).

In an alternate example, the cure is effected after the filament winding sequence with the uncured vessel transferred to a rotating fixture incorporating a chuck. In so doing, the winder is available to begin the next winding sequence. If the winding sequence is shorter that the cure sequence, multiple cure fixtures could be employed.

Support member 6 permits liner 100 to be rotated longitudinally about its axis as uncured epoxy impregnated filamentary material is applied and wound around the outer surface of liner 100.

In certain examples, induction heating is used to effect curing from the inner surface of vessel to the outer surface. Induction heating is used to heat the metallic material within the liner, which in turn heats the inner surface of the liner. As discussed further below, the vessel is rotated during heating which results in the uniform heating of the interior surface of the liner vessel by the heated metallic material.

A skilled worker will appreciate that the specific configuration of the heat induction coil and parameters used (e.g., operating frequency, coupling distance, power, and the like) will vary according to the application, needs and preferences of the intended use. Additionally, selection of the specific components used may be based on various additional criteria, including for example, but not limited to, cost, availability, downstream application, and safety.

In a specific example, to effect curing, the liner is rotated longitudinally about its axis during the heating by the induction coil. As will be appreciated by the skilled worker, the rate(s) of rotation of the liner will be determined, in part, by the nature, chemistry and/or composition of the resin within the filament/resin matrix and/or the variable viscosity of the term of the reaction.

In one example, the induction coil is disposed external to the liner.

In one example, the induction coil is disposed within the inner volume of the liner.

In FIG. 1, heat induction coil 10 is placed adjacent to liner 100. In this embodiment, heat induction coil 10 is external to liner 100. Heat induction coil 10 is typically purpose wound for each application. In one example, heat induction coil 10 is made of copper tubing through which cooling water is flowing. They can in some instances be of solid copper but in this instance they are either of extremely low power or are designed to operate in an elevated temperature environment.

Heat induction coil 10 can be activated either during application of uncured filamentary material, subsequent to or during application, in order to provide energy to metallic material 2.

When heat induction coil 10 is activated, energy from heat induction coil 10 is provided to metallic material 2 and is heated.

The energy applied to metallic material 2 is controlled through use of contact or non-contact temperature monitoring, which is operatively associated with a controlling means, such as a process controller, which adjusts the power supply so as to provide discrete temperature control throughout the heating.

In one example, a temperature sensor, including but not limited to, a thermocouple, a resistance temperature detector (RTD), optical pyrometer, infrared sensor, or alternate device which produces a signal in proportion to the change in temperature sensed, transmits measurements to a temperature process control which varies the output of the induction power supply accordingly to achieve a steady state temperature at an optimum selectable level to permit optimum curing.

In one example, the temperature is monitored indirectly using an infrared sensor monitoring the outer surface temperature of the uncured work piece. In an additional example, a ramp and hold function on the set point of the process controller prevents excessive thermal energy being applied during the early stages of the heat up process.

The temperature sensor can be mounted directly on the either the interior or exterior wall of the vessel or can be suspended within the vessel and exit through a bulkhead fitting to preserve the integrity of the vessel

In FIG. 1, the temperature of metallic material 2 is measured by an infrared (IR) sensor 12 located within interior volume 14 of liner 100. The sensor leads exit liner 100 though aperture 4 and support member 6, and are connected using an electrical slip ring assembly 16.

In another example, in the case in which liner 100 is open to the atmosphere, an IR sensor is located exterior to liner 100, and a slip ring assembly is not required.

In the case of a metallic liner, induction heating may also result in the heating of a portion the liner directly by the induction heater, as well as metallic material.

In one example, the filament(s) used in the production of the work piece are substantially refractory to inductive heating; the filament(s) applied to the vessel are not heated by induction heating.

In another example of this embodiment, induction heating is used to heat the inner surface of vessel 100, with a minimal or reduced amount of metallic material 2 required or with no metallic material required. In this example, the heat produced by the heat induction coil heats the inner surface of vessel 100.

In one example, the induction coil is commercially available.

In another example, the induction coil is potted in epoxy, or other resin(s), to protect the coils from damage and/or contamination in the process.

In another specific example, the induction coil is generally “C” shaped, and concentrates the output of the induction coil within the “C” of the induction coil. In this example, the output from the “C” shaped coil radiates on to a lower half of the mandrel.

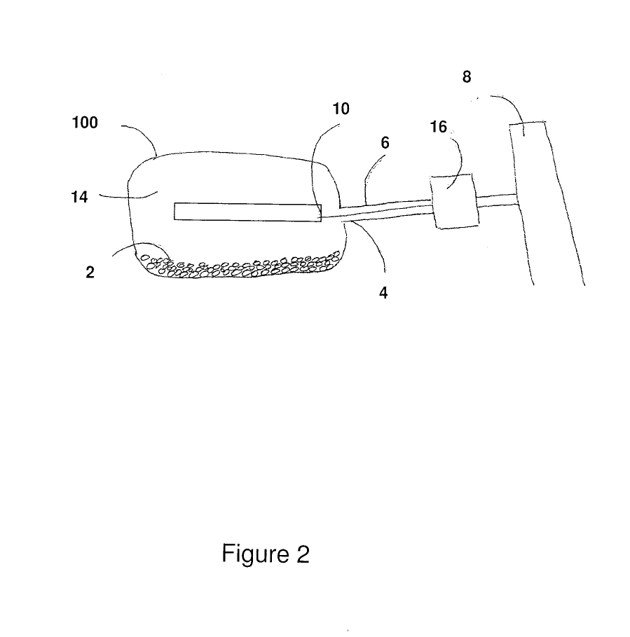

FIG. 2 depicts an alternate embodiment of the present invention. In FIG. 2, heat induction coil 10 is disposed within the inner volume of liner 100.

As with the embodiment of FIG. 1, induction heating is used to effect curing from the inner surface of vessel to the outer surface. Induction heating is used to heat the metallic material within the vessel, which in turn heats the inner surface of the liner vessel. As above, the vessel is rotated during heating which results in the heating of the interior surface of the liner vessel by the heated metallic material.

Heat induction coil 10 is activated either during application of uncured filamentary material to vessel 100 or subsequent to application, in order to provide energy to the metallic material within the inner volume of the liner.

In use, as the liner is rotated, metallic material 2 is in heat transfer relation with the inner surface of liner 100. When heated, the metallic material transfers heat directly to the inner surface of liner 100.

In one example of this embodiment, the depth of penetration of the induction field used during heating is selected so as to extend to metallic material 2, but not to the filamentary material on the outer surface of liner 100. In use, only metallic material 2 is heated, and this example is suitable for use with filamentary material that comprises conductive fibers, such as carbon fiber. In one example, a rotary union and bulk head permits the induction coil to remain stationary as the pressure vessel rotates

In another example of this embodiment, the depth of penetration of the induction field used during heating is selected so as to extend to metallic material 2, and may also extend to the filamentary material on the outer surface of liner 100. In use, metallic material 2 is heated, and this example is suitable for use with filamentary material that does not comprise conductive fibers.

It will be appreciated that the induction power can configured so as to induce an appropriate amount of energy into the carbon fiber so as to heat the carbon fiber but not damage it, thereby causing the resin saturating fibers to heat and effect a cure.

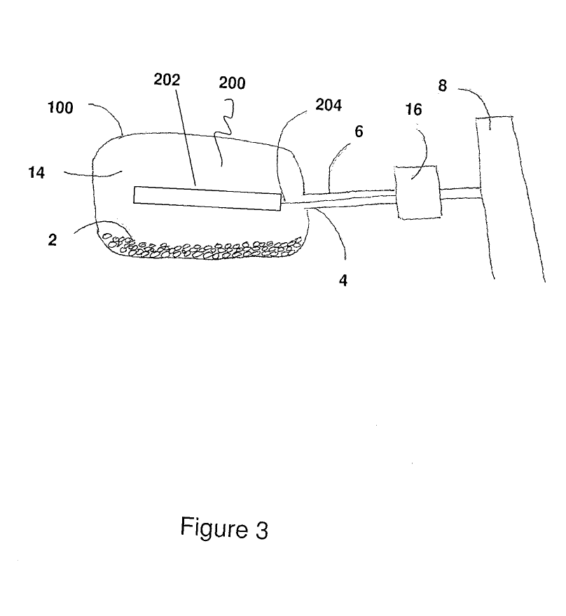

FIG. 3 depicts an alternate embodiment of the present invention. In FIG. 3, a radiant heating is used for curing of the filament/resin matrix from the inner surface of the filament wound work piece to the outer surface.

In one example of this embodiment, radiant heater coil 200 is disposed within liner 100 by insertion through support member 6 and aperture 4. Radiant heater 200 is sized for insertion through the open space of these components. Radiant heater coil 200 remains stationary within liner 100 as liner 100 rotates. Radiant heater coil 200 comprises heated section 202 and unheated section 204. Heated section 202 is configured to the interior length of the vessel. Radiant heater coil 200 is powered electrically and is controlled by typical process control practices, as defined earlier. The radiant energy provided causes the resin to cure from the liner side out to the exterior surface of the vessel.

In one example of this embodiment, radiant heating is used to heat metallic material 2 within vessel 100, which in turn heats the inner surface of the vessel 100. As above, the vessel is rotated during heating which results in the heating of the interior surface of the liner vessel by the heated metallic material.

The selection of the desired temperature(s) to cure the pressure vessel is dependent on the chemistry of the polymer used and the thermal demands of that polymer in its cure stage. In one example, a typical cure temperature of about 350 F is used for epoxy based resins. Suitable temperatures and times are defined by the resin chemistry of the resin selected by the product designer, as appreciated by the skilled worker.

In another example of this embodiment, radiant heating is used to heat the inner surface of vessel 100, with a minimal or reduced amount of metallic material 2 required or with no metallic material required. In this example, the heat produced by radiant heat coil 200 heats the inner surface of vessel 100.

It will be appreciated that the rate of rotation of the vessel (e.g., the RPM value) will vary. In one example, the RPM value is in the range of about 5 to about 10 RPM. This range has been determined based on the viscosity of the resin as it reaches the glass transition temperature just prior to crosslinking and curing. The resin, when in that state is of very low viscosity. The RPM range selected promotes homogeneous spread of the resin with the matrix while maintaining the resin within the matrix during rotation.

Once cured, the composite vessel is allowed to cool.

In another embodiment of the present application, metallic material 2 is a low melting point alloy such as bismuth/antimony or other alloys having predictable melting points. In one example, the melting point of metallic material 2 is about the same as the temperature needed to effect cure of the filamentary material and resin used in the manufacture of the composite vessel.

In one example, metallic material 2 comprises spheres and/or irregular shapes of the low melting point metallic material 2.

In use, in this embodiment, metallic material 2 is placed within interior volume 14 of liner 100 and attached to support member 6 as described above.

Liner 100 is rotated as energy is used to heat metallic material 2 such that it changes phase from solid to substantially liquid. In one example, an induction coil is used and is disposed external to the liner. In one example, an induction coil is used and is disposed within the inner volume of the liner. In another example, a radiant heat coil is used. The heated substantially liquid metallic material 2 then coats the inner surface of liner 100. The heated liquid metallic material 2 is in heat transfer relation with the inner surface of liner 100 and so transfers heat to the inner surface of liner 100 during heating and rotation. This heat transfer in turn provides energy to the filamentary material and resin so as to effect cure of the composite vessel.

In one example, once the cure is complete, liner 100 is removed from support 6 and the heated liquid metallic material 2 is removed from interior volume 14.

In another example, once the cure is complete, the composite vessel is allowed to cool, which causes the liquid metallic material 2 to harden. Liner 100 is then heated so as to cause metallic material 2 to liquefy. The heated liquid metallic material 2 may then be removed from interior volume 14.

In another example, the solid metal remains in the vessel coating the vessel inner wall.

The removed metallic material 2 can, optionally, be reused in subsequent applications.

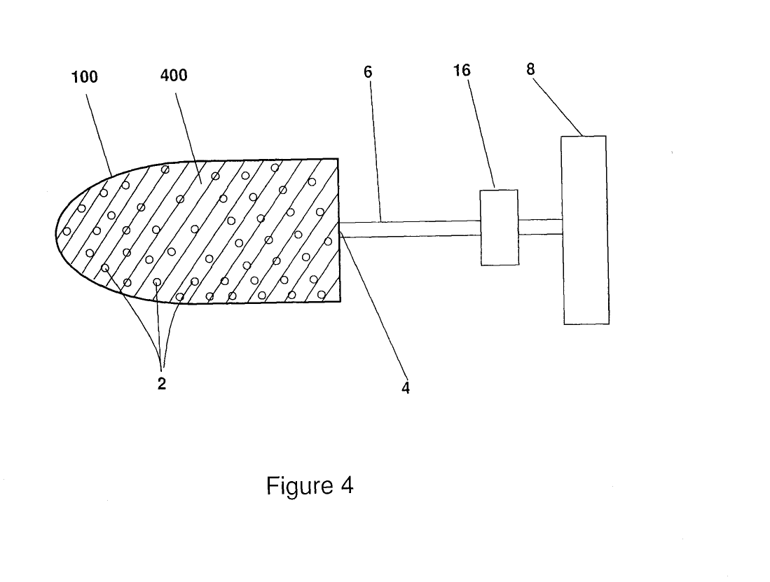

FIG. 4 depicts an alternate embodiment of the present invention. In the Example of FIG. 4, sacrificial mandrel 400 occupies the interior volume of liner 100. Sacrificial mandrel 400 is formed from of a material which is readily crushed or is soluble in a liquid such as water. Examples of suitable materials include, but are not limited to plaster, foundry sand and/or the like.

In another example, sacrificial mandrel 400 is precast and liner 100 is not used. In this example filaments may be wound directly on the outer surface of the sacrificial mandrel.

Metallic material 2 is dispersed throughout sacrificial mandrel 400. In one example, nano size or micro size particles are dispersed throughout sacrificial mandrel 400. In another example, nano size or micro size particles are dispersed homogeneously throughout sacrificial mandrel 400. The amount of metallic material 2 used is sufficient to cause the sacrificial mandrel 400 to absorb heat when an external induction field is applied to the sacrificial mandrel 400, and in turn, transfer heat to the inner surface of liner 100 (or the filament and resin if a liner is not used). Sacrificial mandrel 400 is heated using an external induction coil as described above. The heated sacrificial mandrel 400 is in heat transfer relation with liner 100 and will effect cure of the filament and resin wound on it.

Temperature control may be achieved either through internal mounted sensors or externally mounted sensors, as described above.

After curing, sacrificial mandrel 400 is removed from the interior volume of liner 100. In one example, a liquid such as water, or other soluble agent can be used to break down sacrificial mandrel 400, which can then be removed through aperture 4. In another example, sacrificial mandrel 400 is subjected to vibration, which would break down sacrificial mandrel 400 in to small particulates which would be poured out of aperture 4.

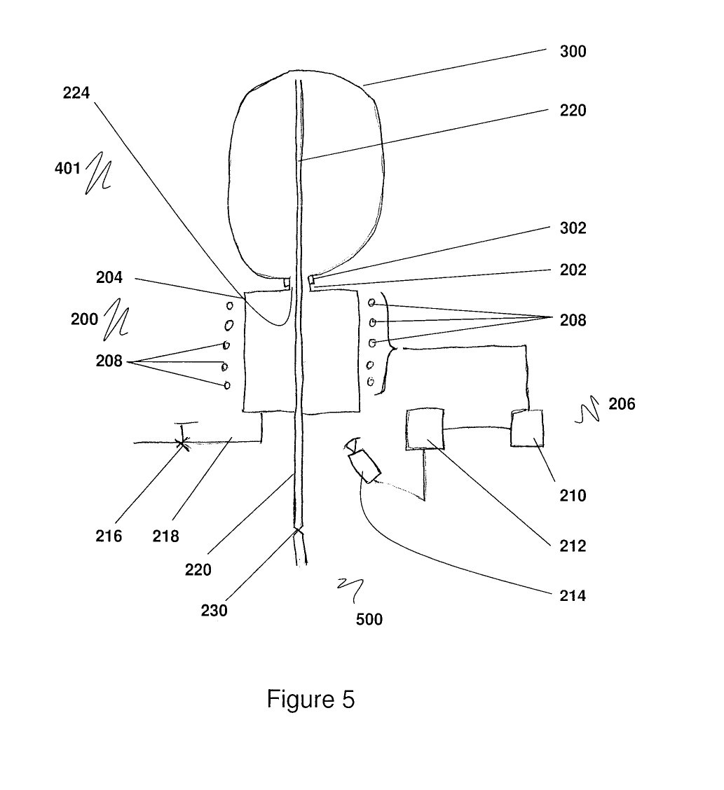

FIG. 5 depicts an alternate embodiment, in which a heated charge fluid vapor is used to heat the interior surface of a liner in order to effect cure an uncured composite vessel.

The liner is a metallic liner or a non-metallic liner. In one example, the liner comprises plastic, including but not limited to, thermoplastic, thermoset plastic and the like. In another example, the liner comprises metal, aluminum, copper, nickel, stainless steel, core materials used in ferrous and non-ferrous casting process such as foundry sand, and the like. In another example, the liner comprises glass, ceramic, fired clay, pottery, non-plastic composite materials, and the like.

In another example, the liner is comprised of inflatable material that is pressurized during the winding and curing processes then deflated for removing from the interior of the article. In this example, the interior of the hollow article may be of a regular or complex geometry. In use, when deflated, the liner may removed from the interior of the article, thereby resulting in an interior volume of the article greater than if the inflatable remains within the article.

To generate the uncured composite vessel, fiber(s) having the required tension strength capability is wound in various layers over the liner to provide a matrix that will allow the vessel to withstand the pressure of its intended use. Such methods are known to the skilled worker. In some example, a liner is attached to a support and rotated about the liner's longitudinal axis so as to wind the fibre(s) around the liner during the application of the fibre(s) and form the composite vessel.

The fiber(s) is saturated with a resin in its uncured state. In a filament winding process, in one example, a band of continuous resin impregnated rovings or monofilaments (also referred to as filamentary material) is wrapped around the liner. In one example of the present invention, the fiber(s) is applied manually to the vessel. In another example, a filament winding machine is used in the application of filamentary material.

As noted above, in previous methods, during the traditional heating process in a cure oven, the liner surface is the last surface to achieve cure temperature. Such heating of the composite pressure vessel from the outer surface of the work piece to the inner surface can cause incomplete cure at the vessel-resin fiber interface. This lack of cure can result in failure in the vessel in use. The trapping of vapors generated during the traditional curing process may result in the formation of bubbles or voids within the winding which makes up the composite vessel wall. This resultant porosity may result in mechanical failure of the composite due to microcracking generally unacceptable void fractions

In the embodiment of FIG. 5, after the uncured fibre(s) have been applied to the liner, the liner is transferred to heating system 400, in which heated charge fluid vapour is applied to the inner surface of the vessel in order to effect cure through phase change from the inner surface of the composite vessel to the outer surface. This method reduces, minimizes or eliminates the problems associated with curing of a composite vessel from the outer surface to the inner surface of the composite vessel. Curing of the work piece from the inner surface to the outer surface permits the vapor(s) produced within the uncured composite matrix during curing to exit from the curing work piece to the atmosphere. This method reduces, minimizes or eliminates the porosity within the composite vessel and provides a more predictable strength of the structure.

Referring to FIG. 5, curing system 401 is configured to provide heated vapour to the interior volume of liner 300.

In the example of FIG. 5, curing system 401 comprises a source of heated charge fluid vapor 200 operable to provide heated charge fluid vapour to the interior volume of liner 300, and outlet means 500 operable to move between an open position and a closed position. In the open position, the interior volume of liner 300 is in fluid communication with the exterior of liner 300. In the closed position, the interior volume of liner 300 is not in fluid communication with the exterior of the liner 300.

In use, source of heated charge fluid vapor 200 introduces heated vapour to interior volume of the liner 300, thereby displacing any gaseous materials within liner 300 though outlet means 500, when outlet means 500 is in the open position. When the interior volume of liner 300 contains the desired amount of heated vapor, outlet means 500 are moved to the close position. In this process, the interior volume of liner 300 is filled with heated charge fluid vapour thereby heating the surface of the liner to the temperature of the heated vapor.

The source of heated vapour 200 comprises chamber 204, and heating system 206. Chamber 204 further comprises a conduit 202 configured for removable attachment of inlet 302 on liner 300. Conduit 202 maintains the interior volume of chamber 204 in fluid communication with the interior volume of liner 300. Chamber 204 is in fluid communication with a source of charge fluid (not shown). Heating system 206 is in heat transfer relation with chamber 204.

In the example of FIG. 5, charge fluid is introduced from the source of charge fluid through fluid conduit 218. Valve 216 is disposed on fluid conduit 218 between the source of charge fluid and chamber 204. Valve 216 is moveable from an open position to a closed position. In the open position, fluid conduit 218 maintains the source of charge fluid in fluid communication with the interior of chamber 204. In the closed position, the source of charge fluid is not in fluid communication with the interior of chamber 204.

In the example of FIG. 5, heating system 206 comprises induction coil 208 which is operatively associated with induction power supply 210 which is in turn operatively associated with process temperature controller 212, which is operatively associated with temperature sensor means 214, such as thermocouple or infrared or other temperature sensor.

As noted above, curing system 401 comprises outlet means 500 operable to move between an open position and a closed position. In the open position, the interior volume of liner 300 is in fluid communication with the exterior of liner 300. In the closed position, the interior volume of liner 300 is not in fluid communication with the exterior of liner 300.

In the example of FIG. 5, outlet means 500 comprises vent tube 220 which enters the interior of chamber 204, where it is fixedly attached. In this example vent tube 220 is welded in place where it exits chamber 204. Vent tube 220 extends through chamber 204 through conduit 202 into the interior volume of liner 300. In this example, liner 300 (which has an uncured pressure vessel attached) is secured to chamber 204 through the fitting on the chamber being threaded into the inside threaded port of the pressure vessel.

Vent tube 220 is sized such that it extends through conduit 202, connecting chamber 204 to the interior volume of liner 300 defining an annulus distance 224 from the outer surface of vent tube 220 to the inner surface of conduit 202. Vent tube 220 extends within the interior volume of liner 300 to the opposite side of liner 300. In one example, vent tube 220 extends to a position about ⅛th inch from the inner surface of liner 300. Vent tube 220 extends beyond chamber 204 and terminates at valve 230 which may be manually or electrically or otherwise automatically operated.

In this example, the cure boundary occurs from the surface of the uncured composite vessel in contact with the liner, and any vapour associated with the cure process vents to atmosphere as the cure boundary moves, ultimately to the outer surface of the reinforcement. In contrast, when the cure occurs in a convection oven, the cure boundary first occurs on the outside surface of the reinforcement causing the vapour associated with the cure boundary moving towards to interior of the reinforcement to be trapped. This causes porosity and delamination of the reinforcement as the vapour displaces uncured resin.

Thus, the process described herein cures the vessel from the inside of the vessel or vessel interior using the heat generated by the phase change of charge fluid at elevated temperatures. In a specific example, a temperature of about 350 F is selected as the target temperature for glass transition (Tg) to occur. In a specific example, the charge fluid is water and the charge fluid vapor is steam.

It will be appreciated that a variety of charge fluids may be used. The charge fluid selected can change from liquid to vapor and has reasonable latent heat values which can be used providing the vapor pressure of the material is acceptable to the structural integrity of the heating/curing system.

Specific example of suitable charge fluids include, but are not limited to, water, isobutene, butane propane, methanol, ethanol and the like.

In use, in one example, an uncured filament wound pressure vessel on liner 300 is removably attached to conduit 202 at inlet 302. All equipment is at or near ambient temperature and all electric heating is unenergized. Charge fluid is placed into chamber 204 by opening valve 216 until chamber 204 is filled. Valve 230 is opened and valve 216 is closed after filling chamber 204. Process controller 212 is energized with a control setpoint of, in one example, 350 F. Controller 212 then causes power supply 210 to provide energy to the induction coil 208. The charge fluid in chamber 204 is heated indirectly as the metal chamber is heated by the induction coil 208. The charge fluid changes phase to vapour from liquid and this vapour migrates into interior of vessel 300 through the conduit 202. This vapour displaces the atmosphere in the interior of vessel 300 which exits through tube 220 due to valve 230 being open. The temperature of the atmosphere exiting conduit 220 via valve 230 is monitored for temperature. As the temperature of the discharge atmosphere reaches a selected control temperature, the non condensable gases and non charge fluid vapor have exited the chamber at which point valve 230 is closed.

It will be appreciated that this effectively creates a closed vessel system in which chamber 204 is an evaporator and the interior of vessel 300, which is substantially free of noncondensible gas or vapour, is now a condenser. In this condition, the temperature of the interior of vessel 300 from chamber 204 to the interior surface of the vessel 300 is isothermal due to the charge fluid within the system changing phase from liquid to vapour and back to liquid as it condenses in surfaces that are of lower temperature than the vapour. The liquid returns to the evaporator for reuse and phase change. It will be appreciated that functionally, this system is a thermosyphon.

As the temperature of the system raises to its controlled setpoint, of about 350 F in the example of water as the charge fluid, the vapour temperature, being isothermal heats the uncured resin within the reinforcement of the composite and affects a complete cure by reaching a Tg of 350 F. Once the temperature set point has been reached an option a soak period may be use to cure the article, the heating system is deenergized and valve 230 is opened to vent the pressure from the interior volumes. Further cooling is accomplished by either leaving the assembly in ambient air or using forced air cooling. When the temperature of the now cured composite article, and in this example a composite pressure vessel, is lowered such that the interior of the vessel has returned to ambient atmospheric pressure it is unthreaded from the chamber assembly and another uncured pressure vessel is mounted on the apparatus at which point the process begins again.

In another example, a plastic vessel liner is used and is pressurized using water. This plastic liner may be rigid and remain within the vessel or article or may be inflatable and be removed from the vessel or article after curing. In this example, the interior of the hollow article may be of a regular or complex geometry. In use, when deflated, the liner may removed from the interior of the article, thereby resulting in an interior volume of the article greater than if the inflatable remains within the article.

In this example a valve, and optionally a ball valve, is disposed at inlet 302 of liner 300, and is operable to allow water to enter the interior of plastic liner 302 and displace all atmosphere within the plastic liner. In the case of the inflatable liner, the ball valve facilitates inflation with compressed air or other gas. The pressurized water or compressed air/gas permits the liner to remain dimensionally stable during the winding of the filament around the plastic liner.

To effect cure of the composite vessel, the plastic liner containing water or compressed air/gas is attached to conduit 202, as shown in FIG. 5. Chamber 204 is pressurized with water to substantially the same pressure as in the interior of liner 300. The ball valve is moved to the open position and the water is therefore free to flow through vent tube 220 and valve 230. Chamber 204 is heated and the resultant vapour produced displaces the water or compressed air/gas from the interior of plastic liner 300 while maintaining the desired internal pressure due to a pressure relief valve (not shown) attached downstream from valve 230. When substantially all the liquid water or compressed air/gas is removed from the interior of liner 300 and replaced by vapour, valve 230 is moved to the closed position, and the cure sequence is completed as described above.

In one example, to enhance the cure process, the cure system described in FIG. 5 may be enclosed in an insulated clam shell reflector to prevent or minimize thermal losses to ambient convective air. This is done, for example, if the winding was of significant cross section, to prevent losses that could potentially slow down the cure at the exterior surface of the vessel.

It will be appreciated that while induction heating is preferred, resistive heating elements could be used to heat chamber 204, but would require much more time to bring the water within the chamber up to heat. When induction heating is employed, the addition of metallic particulate materials to the chamber will promote the speed of phase change of the water by increasing the heated surface area in contact with the water.

It will also be appreciated from the foregoing description of the specific example in FIG. 5, that the uncured pressure vessel is oriented vertically above the in order to permit condensate return flow. Control of low viscosity resin flow during the cure sequence may be achieved if required by the use of “veil” or “peal ply” fabric which is wound around the uncured composite surface under tension after winding. The fabric then encases the uncured composite and contains the resin to prevent it flowing towards gravity during its liquid uncured state. This fabric is typically “peeled” away from the cured composite after the cooling cycle. Some resin formulations maintain high viscosity during the cure process and would therefore not require these fabrics.

In another example the uncured vessel can be encased in an inflatable bladder or vacuum bag which, when inflated or activated, exerts compression pressure on the outside of the uncured outer surface of the vessel, holding the resin fiber matrix in position.

In another example, the system defined above in FIG. 5 can be oriented horizontally. In this example, the charge fluid in chamber 204 is of sufficient volume to permit condensate to reside in the vessel 300, which is acting as the condenser, while still having a reservoir of charge fluid in chamber 300 sufficient for the duration of the cure time at set point. When the cure time is completed the system is depressurized and the cured pressure vessel is removed from the cure system. At this time the condensate residing in the pressure vessel is removed, and the system is recharged for the next cure

It will be further appreciated that the interior of chamber 204 may be modified using various textures, baffles and other means to increase the surface area and thereby increase the rate of phase change within the chamber.

In another example of the system of FIG. 5, after valve 216 is closed, valve 230 is opened and attached to vacuum means, such as a vacuum pump. The atmosphere within the vessel 300 and chamber 204 is removed so as to create a high vacuum. This removes all air within these chambers at which time valve 230 is closed and so as to create a closed vessel thermosyphon system.

In another embodiment of the present invention, the composite vessel is prepared using a “B” stage cure followed by an “A” stage cure.

In the “B” stage cure, the composite vessel is initially cured as described above, and as shown in the Figures. During the “B” stage cure, the uncured resin is converted from liquid to solid during the application of heat to the inner surface of the composite vessel. As in the examples above, during “B” stage curing, heat is applied to the inner surface of the vessel in order to affect cure from the inner surface of the composite vessel to the outer surface. Curing of the work piece from the inner surface to the outer surface permits the vapor(s) produced during curing to exit from the curing work piece to the atmosphere. This method reduces, minimizes or eliminates the porosity within the composite vessel and provides a more predictable strength of the structure

The composite vessel is then subjected to an “A” stage cure. In the “A” stage cure (also referred to as a “soak”), the composite vessel from the “B” stage is subjected to heating at an elevated temperature, for example using an over. During “A” stage curing, the resin is further solidified or set, so that it achieves higher mechanical properties.

The skilled worker will appreciate that the use of “B” stage and “A” stage curing is useful in the case of certain resin formulations in which the resin is cured very slowly using a ramp to raise the temperature, and reduces or minimizes the production of entrapped vapour. While not wishing to be bound by theory, it is thought that this further curing over time lengthens the molecular chains within the resin making it stronger.

All publications, patents and patent applications mentioned in this Specification are indicative of the level of skill those skilled in the art to which this invention pertains and are herein incorporated by reference to the same extent as if each individual publication patent or patent application was specifically and individually indicated to be incorporated by reference.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

1. A method of manufacture of a composite article using a filamentary material and a liner, comprising:
a. providing a material in heat transfer relation with the inner surface of said liner;
b. applying uncured filamentary material to the outer surface of said liner; and
c. heating a portion of said material in heat transfer relation with the inner surface of said liner, wherein heating said portion of said material effects cure of said composite article.

2. The method of claim 1, wherein said material comprises a metallic material.

3. The method of claim 2, where said metallic material comprises copper, nickel, steel, aluminum, bismuth, or antimony.

4. The method of claim 3, wherein applying said uncured filamentary material comprises rotating said liner about an axis of said liner and applying said filamentary material around the outer surface of said vessel.

5. The method of claim 3, wherein applying said uncured filamentary material comprises maintaining said liner in a fixed position and rotating dispensing means around the outer surface of said liner so as to apply said filamentary material.

6. The method of claim 3, wherein applying said uncured filamentary material comprises rotating said liner about an axis of said liner and applying said filamentary material around the outer surface of said vessel and rotating dispensing means around the outer surface of said liner so as to apply said filamentary material.

7. The method of claim 4, wherein said axis is a longitudinal axis.

8. The method of claim 1, wherein said heating of said portion of said material occurs subsequent to applying said uncured composite materials to said outer surface of said liner.

9. The method of claim 1, wherein said heating of said portion of said material occurs concurrently with applying said uncured composite materials to said outer surface of said liner.

10. The method of claim 1, further comprising monitoring and controlling the temperature of said material in said liner.

11. The method of claim 10 wherein said monitoring and controlling is effected using a contact sensor or a non contact sensor, and a control loop operatively associated with an induction power supply and a heat source to maintain a set temperature.

12. The method of claim 11, wherein said heat source is internal to said liner or external to said liner.

13. The method of claim 12 wherein said heat source is an induction coil.

14. The method of claim 8 further comprising heating the outer surface of said uncured article.

15. A method of manufacture of a composite article using a filamentary material and a liner, comprising:
a. applying uncured filamentary material to the outer surface of said liner; and
b. providing a heated charge fluid vapor in heat transfer relation with the inner surface of said liner so as to effect cure of said uncured filamentary material, wherein said heated charge fluid vapor is in isothermal conditions in the interior of said liner.

16. The method of claim 15, wherein said providing said heated charge fluid vapor comprises, providing a charge fluid to a chamber in heat transfer relation with a heating system, wherein said heating system is configured to heat said charge fluid so as to produce a heated charge fluid vapor.

17. The method of claim 16, wherein said heating system comprises, an induction heating coil in heat transfer relation with said chamber and a said induction heating coil is operatively associated with a contact temperature sensor or a non contact temperature sensor and a control loop operatively associated with an induction power supply, wherein said heating system is operable to maintain a set temperature.

18. A system for the manufacture of a composite article using a filamentary material wound on a liner, comprising:
a. a source of heated vapor in fluid communication with the interior of said liner and configured to provide heated vapor to the interior of said liner; and
b. outlet means movable between an open position and a closed position, wherein in said open position the interior of said liner is in fluid communication with the exterior of said liner, wherein in said closed position the interior of said liner is not in fluid communication with the exterior of said liner,
wherein said source of heated vapor is operable to provide said heated vapor to the interior of said liner under isothermal conditions.

19. The system of claim 18, wherein said source of heated vapor comprises,
a. a chamber for receiving a charge fluid from a source of charge fluid; and
b. a heating system configured to heat said charge fluid in said chamber.

20. The system of claim 19, wherein said heating system comprises, an induction heating coil in heat transfer relation with said chamber and a said induction heating coil is operatively associated with a contact temperature sensor or a non contact temperature sensor and a control loop operatively associated with an induction power supply, wherein said heating system is operable to maintain a set temperature.

21. A system for the manufacture of a composite article using a filamentary material wound on a liner, comprising,
a. a material in heat transfer relation with the inner surface of said liner;
b. heating means operable to heat a portion of said material in heat transfer relation with the inner surface of said liner, wherein heating said portion of said material effects cure of said composite vessel.

22-31. (canceled)
